(19) United States
(12) Patent Application Publication
(10) Pub. No.: US 2022/0391308 A1
(43) Pub. Date: Dec. 8, 2022

(54) FUNCTIONALLY TARGETED UNIT TESTING

(71) Applicant: Infor (US), LLC, New York, NY (US)

(72) Inventors: Jeffrey Allen Brown, Colorado Springs, CO (US); Ranasinghage Piyaviraj Ranasinghe, Piliyandala (LK)

(21) Appl. No.: 17/328,903

(22) Filed: May 24, 2021

(51) Int. Cl. G06F 11/36; G06N 20/00

(52) U.S. Cl. CPC G06F 11/3688; G06F 11/3692; G06F 11/3684; G06N 20/00

(57) ABSTRACT

Various embodiments of the present invention provide methods, apparatus, systems, computing devices, computing entities, and/or the like for performing functionally targeted unit testing by executing a set of functionally targeted testing operations with respect to a subset of one or more methods within the target software code unit that are associated with a functionally targeted method category, where the method category for a method is generated by utilizing a method category determination machine learning model and based at least in part on a set of method features for the method.

### BACKGROUND

Various embodiments of the present invention address technical challenges related to performing unit testing of software applications. Various embodiments of the present invention address the shortcomings of existing unit testing frameworks.

### BRIEF SUMMARY

In general, embodiments of the present invention provide methods, apparatus, systems, computing devices, computing entities, and/or the like for performing functionally targeted unit testing by executing a set of functionally targeted testing operations with respect to a subset of one or more methods within the target software code unit that are associated with a functionally targeted method category, where the method category for a method is determined based at least in part on a method category for the method that is generated by utilizing a method category determination machine learning model and based at least in part on a set of method features for the method.

In accordance with one aspect, a method is provided. In one embodiment, the method comprises: identifying one or more methods within the target software code unit; for each method, determining, by utilizing a method category determination machine learning model and based at least in part on a set of method features for the method, a method category for the method; and executing the set of functionally targeted testing operations with respect to a subset of the one or more methods that are associated with a functionally targeted method category.

In accordance with another aspect, a computer program product is provided. The computer program product may comprise at least one computer-readable storage medium having computer-readable program code portions stored therein, the computer-readable program code portions comprising executable portions configured to: identify one or more methods within the target software code unit; for each method, determine, by utilizing a method category determination machine learning model and based at least in part on a set of method features for the method, a method category for the method; and execute the set of functionally targeted testing operations with respect to a subset of the one or more methods that are associated with a functionally targeted method category.

In accordance with yet another aspect, an apparatus comprising at least one processor and at least one memory including computer program code is provided. In one embodiment, the at least one memory and the computer program code may be configured to, with the processor, cause the apparatus to: identify one or more methods within the target software code unit; for each method, determine, by utilizing a method category determination machine learning model and based at least in part on a set of method features for the method, a method category for the method; and execute the set of functionally targeted testing operations with respect to a subset of the one or more methods that are associated with a functionally targeted method category.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example Automated Unit Test Generation Engine (AUGIE) computing entity in accordance with some embodiments discussed herein.

FIG. 3 provides an example external computing entity in accordance with some embodiments discussed herein.

FIG. 4 is a block diagram of a software architecture for the AUGIE computing entity in accordance with some embodiments discussed herein.

FIG. 5 provides an operational example of a user-initiated unit testing command that is associated with a target software code unit that is a class in accordance with some embodiments discussed herein.

FIG. 6 provides an operational example of a user-initiated unit testing command that is associated with a target software code unit that is a method in accordance with some embodiments discussed herein.

FIG. 7 provides an operational example of a configuration file that may be described by a user-initiated unit testing command in accordance with some embodiments discussed herein.

FIG. 8 is a data flow diagram of an example process for generating a structured class-wise representation of a target software code unit in accordance with some embodiments discussed herein.

FIG. 9 provides an operational example of an off-heap data structure storing a structured class-wise representation for a package in accordance with some embodiments discussed herein.

FIG. 10 provides an operational example of a method category determination machine learning model in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Overview and Technical Advantages

Provided below are techniques for executing functionally targeted unit testing operations. An important objective of the noted techniques is to limit unit testing operations on critical code segments, rather than all code segments. Achieving this objective reduces the number of erroneous and/or excessive unit testing operations by automated software testing platforms. In some embodiments, reducing the number of erroneous and/or excessive unit testing operations improves the operational efficiency of test automation platforms by reducing the number of processing operations that need to be executed by the noted test automation platforms to enable software testing operations (e.g., automated software testing operations). By reducing the number of processing operations that need to be executed by the noted test automation platforms to enable software testing operations, various embodiments of the present invention make important technical contributions to the field of software application testing.

Furthermore, various embodiments of the present invention address problems associated with scalability of unit testing solutions. Scalability refers herein to the ability of the proposed solutions to enable using more attributes for detecting functionally significant code segments. In this sense, various embodiments of the present invention enable scalable functionally significant code identification by training a retrainable method category determination machine learning model to generate machine-learning-based method categories for particular methods. Therefore, various embodiments of the present invention address technical issues associated with scalability of automated unit testing in a functionally targeted manner.

Moreover, various embodiments of the present invention improve the operational reliability and computational efficiency of software solutions which are generated using unit testing techniques described herein. As described in-depth throughout this disclosure, various embodiments of the present invention provide methods, apparatus, systems, computing devices, computing entities, and/or the like for performing functionally targeted unit testing by executing a set of functionally targeted testing operations with respect to a subset of one or more methods within the target software code unit that are associated with a functionally targeted method category, where the method category for a method is generated by utilizing a method category determination machine learning model and based at least in part on a set of method features for the method. The noted techniques enable improved unit testing solutions that lead to detecting operational errors in functionally significant portions of the code and fixing those operational errors. In this way, various embodiments of the present invention improve the operational reliability and computational efficiency of software solutions which are generated using unit testing techniques described herein.

### II. Definitions

The term “functionally targeted unit testing operation” may refer to a data entity that is configured to describe a set of computer-implemented actions that are configured to perform software testing (e.g., automated software testing) on a portion of a target software code unit that is determined to be a functionally significant portion in a manner that indicates a need for performing a unit testing operation with respect to the portion. In some embodiments, when a portion of a target software code unit that is determined to be a functionally significant portion in a manner that indicates a need for performing a unit testing operation with respect to the portion, the portion is deemed to have a functionally targeted category. For example, when a method of a target software code unit that is determined to be a functionally significant method in a manner that indicates a need for performing a unit testing operation with respect to the method, the method is deemed to have a functionally targeted method category.

The term “structured class-wise representation” may refer to a data entity that is configured to describe a set of class feature data objects that include a class feature data object for each class of a set of packages that are deemed to be associated with the target software unit. For example, if the target software unit is associated with one package, the structured class-wise representation may describe a key-value pair that describes the package using the key and an array of class feature data objects for each class in the package as the value. As another example, if the target software unit is associated with multiple packages, the structured class-wise representation may describe a set of key-value pairs, where each key-value pair corresponds to a package that is associated with the target software unit and describes the corresponding package using the key and an array of class feature data objects for each class in the corresponding package as the value. Thus, as described in the preceding two examples, the structured class-wise representation may describe one or more key-value pairs, where each key-value pair describes the class feature data objects for a set of classes in a package. For example, a key-value pair in a structured class-wise representation may describe, as the value of the key-value pair, a set of JavaScript Object Notation (JSON) objects, where JSON object corresponds to the class feature data object of a class in the package described by the key of the key-value pair.

The term “inherent package list” may refer to a data entity that is configured to include, in addition to a corresponding identified package, any packages in a set of interdependent modules for a module that is associated with the identified package. In some embodiments, to generate the inherent package checklist for an identified package, a parsing engine: (i) identifies the target module associated with the package, (ii) identifies the project associated with the target module, (iii) identifies the Project Object Model (POM) file associated with the project, (iv) determines a set of interdependent module names for a set of interdependent modules for the target module based at least in part on the POM file, (v) scans the POM file based at least in part on the set of interdependent module names to determine the package list for each of the interdependent modules, and (vi) generates the inherent package list based at least in part on each package list for an interdependent module.

A “method-related feature” may refer to a data entity that is configured to describe a feature of a method that is determined based resolving a method call for a method. In some embodiments, to resolve a method call, at least one of the following information are captured for each method call: whether the corresponding method is static, whether the corresponding method is abstract, whether the corresponding method has a void type, method return information for the corresponding method (e.g., whether the corresponding method returns anything, the data type returned by the corresponding method, and/or the like), method argument parameter information for any argument parameters of the corresponding method, method variable name information for any variables declared in the corresponding method, method variable data type information for any variables declared in the corresponding method, method object declaration information for any object declarations in the corresponding method, method loop information for any loops in the corresponding method, method conditional statement information for any conditional statements in the corresponding method, and/or the like.

The term “off-heap data structure” may refer to a data entity that is configured to describe a structured class-wise representation that is stored in a non-heap computer storage medium. In some embodiments, storing the structured class-wise representation as an off-heap data structure is important because off-heap data structures serialize objects on disks rather than by holding them in memory, which will avoid performance issues of on-head collections such as delays or program terminations due to insufficient memory resulted from having a large number of object creation. In some embodiments, storing the structured class-wise representation as an off-heap data structure is important because off-heap data structures avoid using excess heap space.

The term “method category” may refer to a data entity that is configured to describe the output of a method category determination machine learning model in relation to whether the method within the context of a target software code unit is deemed to be a functionally significant method in a manner that indicates a need for performing a unit testing operation with respect to the method. In some embodiments, the method category is generated by a method category, such as a method category determination machine learning model that is trained using training data inferred based at least in part on existing unit tests for software programs.

The term “method category determination machine learning model” may refer to a data entity that is configured to describe parameters, hyper-parameters, and/or defined operations of a machine-learning-based model that is configured to process a set of method features for a method to determine a method category for the method. In some embodiments, the method category determination machine learning model comprises an ensemble sub-model that is configured to combine the outputs of two or more prediction sub-models to generate the method category. For example, the method category determination machine learning model may comprise n prediction sub-models, where each prediction sub-model is associated with a trained, tuned, and/or preconfigured model weight and is configured to generate an output describing whether an inferred prediction about whether a method is deemed to be a functionally significant method in a manner that indicates a need for performing a unit testing operation with respect to the method. In the noted example, the ensemble sub-model may be configured to apply the model weight for each prediction sub-model to the per-model output of the prediction sub-model to generate a weighted per-model output for the prediction sub-model. Moreover, the ensemble sub-model may further be configured to combine each weighted per-model output for a prediction sub-model to generate the method category. In some embodiments, the input to the method category determination machine learning model include a vector or a matrix that describes a set of method features for an input method. In some embodiments, the output of the method category is a method category for the input method that may be an atomic value or a vector. In some embodiments, when the method category determination machine learning model comprises a set of prediction sub-models and an ensemble sub-model: (i) the input to each prediction sub-model may include a vector or a matrix that describes a set of method features for an input method, (ii) the output of each prediction sub-model may include a per-model output that may be an atomic value or a vector, (iii) the inputs to the ensemble sub-model may include an output vector that describes each per-model output of a prediction sub-model and a weight vector that describes each model weight for a prediction sub-model, and (iv) the output of the ensemble sub-model may be a method category for the input method that may be an atomic value or a vector.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

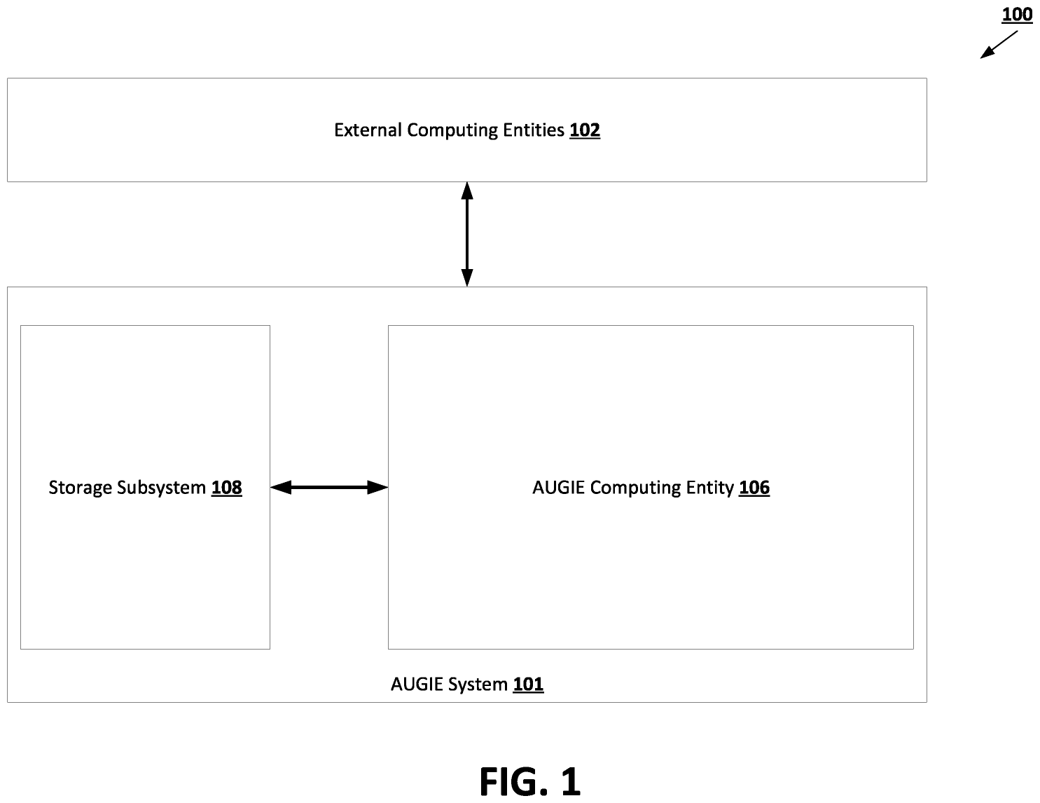

FIG. 1 is a schematic diagram of an example architecture 100 for performing unit testing (e.g., automated unit testing). The architecture 100 includes an AUGIE system 101 configured to receive unit testing requests from external computing entities, perform unit testing requests to generate unit testing outputs, and provide unit testing outputs to the external computing entities 102.

In some embodiments, the AUGIE system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The AUGIE system 101 may include an AUGIE computing entity 106 and a storage subsystem 108. The AUGIE computing entity 106 may be configured to receive unit testing requests from external computing entities, perform unit testing requests to generate unit testing outputs, and provide unit testing outputs to the external computing entities 102. The storage subsystem 108 may be configured to store input data used by the AUGIE computing entity 106 to perform functionally targeted unit testing. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary AUGIE Computing Entity

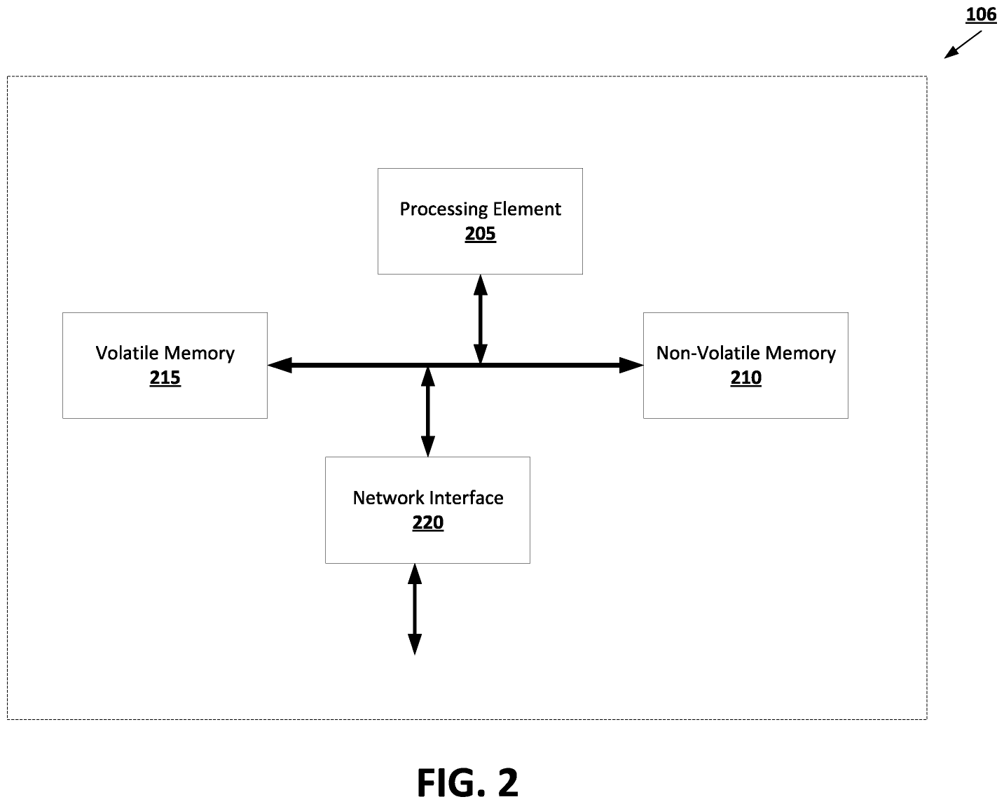

FIG. 2 provides a schematic of an AUGIE computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the AUGIE computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the AUGIE computing entity 106 may include or be in communication with one or more processing elements 205 (also referred to as processors, processing circuitry, and/or similar terms used herein interchangeably) that communicate with other elements within the AUGIE computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the AUGIE computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity— relationship model, object model, document model, semantic model, graph model, and/or the like.

In one embodiment, the AUGIE computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the AUGIE computing entity 106 with the assistance of the processing element 205 and operating system.

As indicated, in one embodiment, the AUGIE computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the AUGIE computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the AUGIE computing entity 106 may include or be in communication with one or more input elements, such as a keyboard input, a mouse input, a touch screen/display input, motion input, movement input, audio input, pointing device input, joystick input, keypad input, and/or the like. The AUGIE computing entity 106 may also include or be in communication with one or more output elements (not shown), such as audio output, video output, screen/display output, motion output, movement output, and/or the like.

### Exemplary External Computing Entity

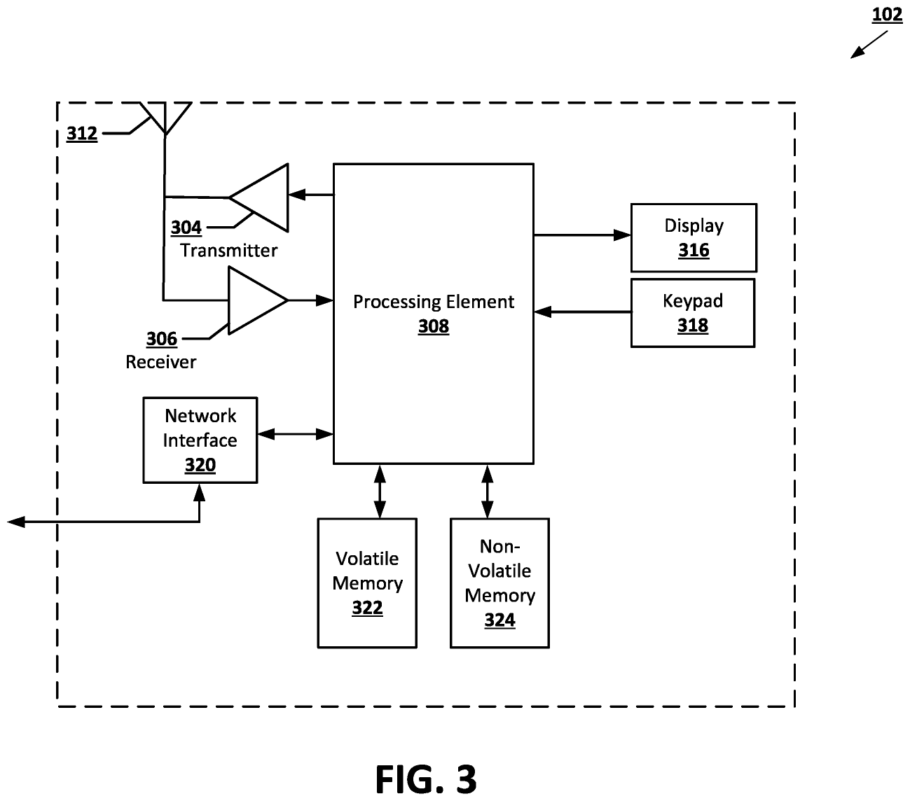

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the AUGIE computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the AUGIE computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the AUGIE computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the AUGIE computing entity 106 and/or various other computing entities.

In another embodiment, the external computing entity 102 may include one or more components or functionality that are the same or similar to those of the AUGIE computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

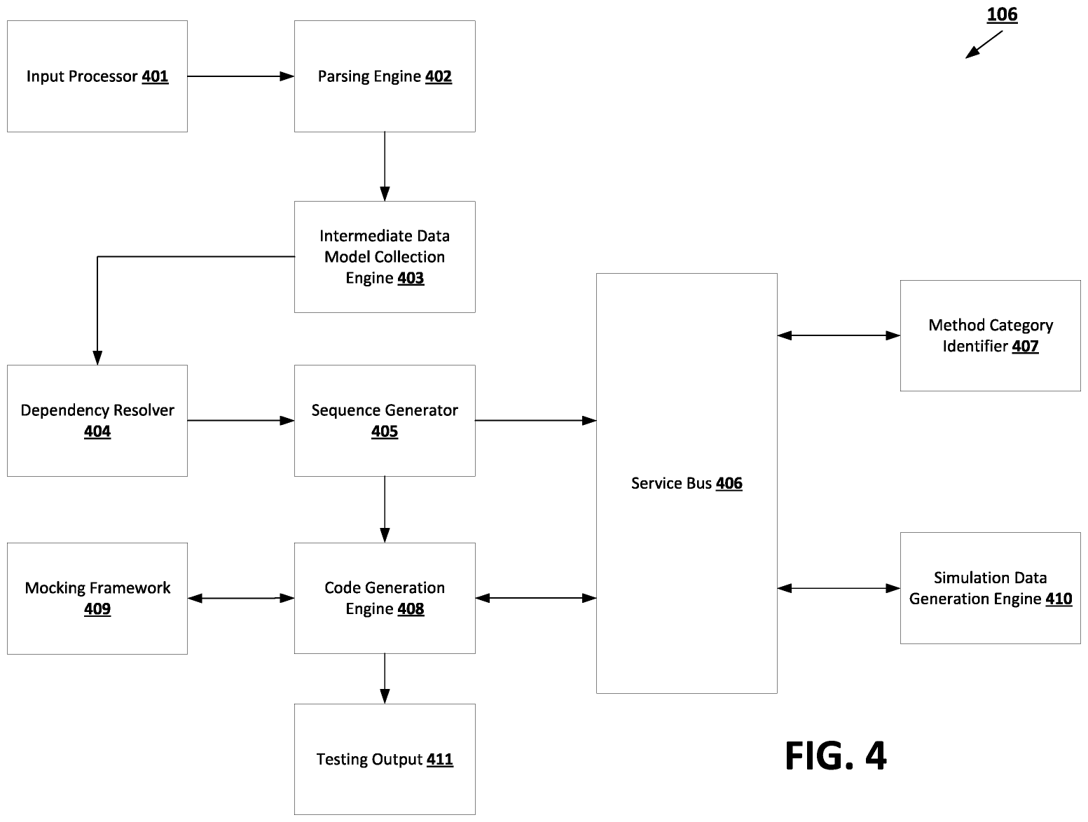

FIG. 4 is a block diagram of a software architecture for the AUGIE computing entity 106. While FIG. 4 depicts the software architecture as being implemented on a single computing entity, a person of ordinary skill in the relevant technology will recognize that the various components of the software architecture can be implemented on two or more distributed computing entities.

The software architecture that is depicted in FIG. 4 includes an input processor 401 that is configured to receive a user-initiated unit testing command to perform a set of functionally targeted unit testing operations with respect to a target software code unit (e.g., a software code file, a software code package, a software code module, a software code class, a software code method, and/or the like). In some embodiments, the input processor 401 is configured to detect input parameters of the user-initiated unit testing command, detect the target software unit based at least in part on the noted input parameters, and provide the target software unit to the parsing engine 402.

The user-initiated unit testing command may be configured to invoke an execution file corresponding to the unit-testing-related functionalities of the AUGIE computing entity 106, such as an executable jar file corresponding to the unit-testing-related functionalities of the AUGIE computing entity 106. In some embodiments, the user-initiated user testing command provides at least one of the following: whether the target software code unit is a class, a package or a module; the path of the target software code unit; and a configuration file that describes various configuration properties of the requested set of functionally targeted unit testing operations.

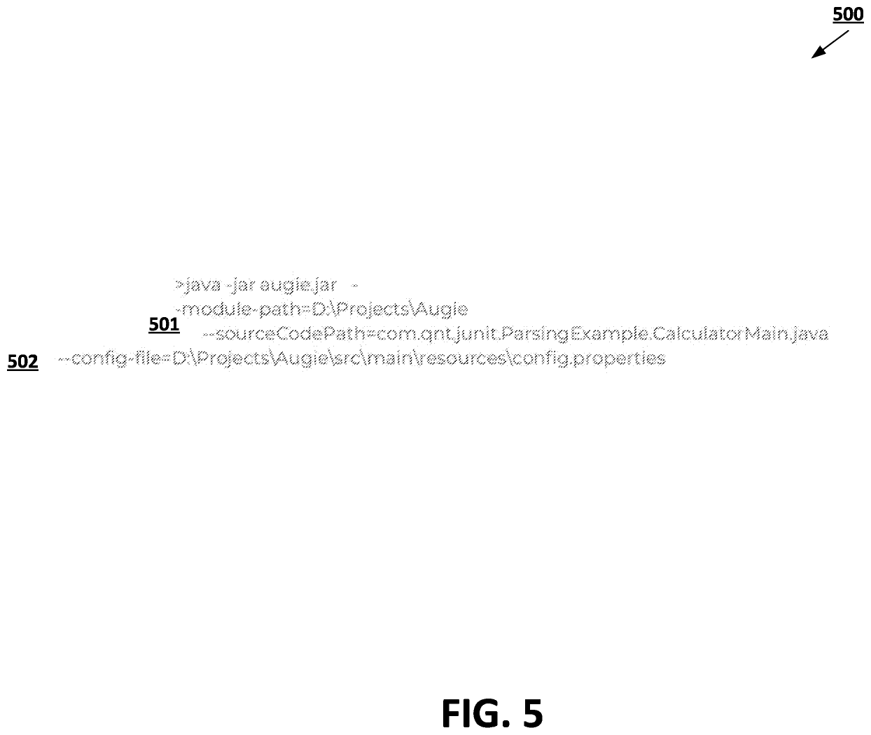

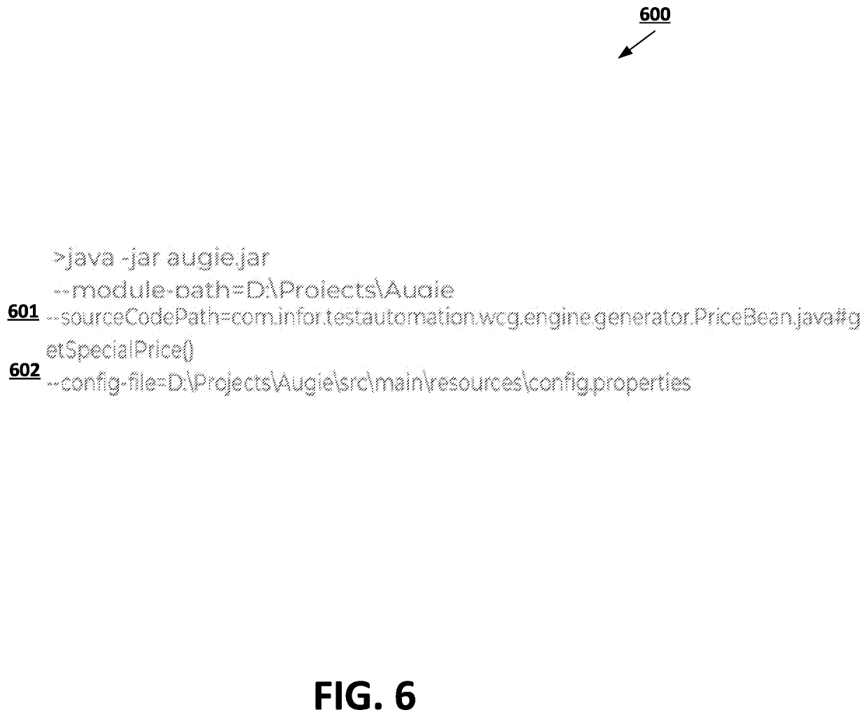

Operational examples of user-initiated unit testing commands are depicted in FIGS. 5-6. In particular, an operational example of a user-initiated unit testing command 500 that is associated with a target software code unit that is a class is depicted in FIG. 5. As depicted in FIG. 5, the user-initiated unit testing command 500 describes the path 501 for the corresponding class and the configuration file 502 for the requested set of functionally targeted unit testing operations. Moreover, an operational example of a user-initiated unit testing command 600 that is associated with a target software code unit that is a method is depicted in FIG. 6. As depicted in FIG. 6, the user-initiated unit testing command 600 describes the path 601 for the corresponding method and the configuration file 602 for the requested set of functionally targeted unit testing operations.

As described above, a user-initiated unit testing command may describe a configuration file that describes various configuration properties of the requested set of functionally targeted unit testing operations. Examples of the configuration properties that may be included in a configuration file that is described by the user-initiated unit testing command may include: the threshold amount of time (e.g., in the number of seconds) that the AUGIE computing entity 106 should spend processing during unit test code generation before skipping or rollback of the unit test code generation, the type of behavior when threshold amount of time is passed (e.g., skipping or rollback), and path of a rules file that may be used by a rule-based engine for the AUGIE computing entity 106.

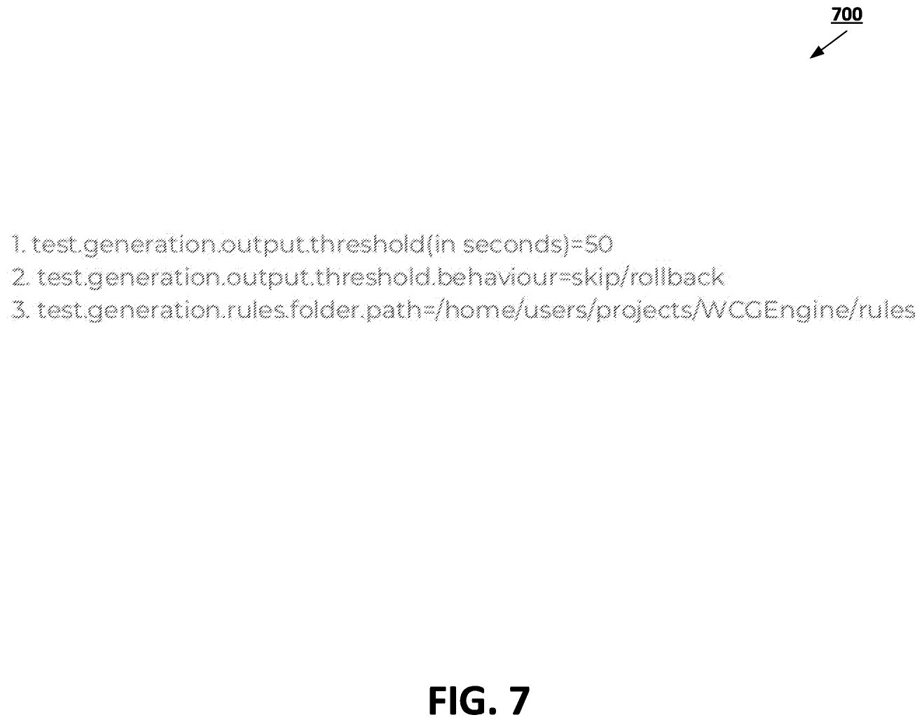

An operational example of a configuration file 700 that may be described by a user-initiated unit testing command is depicted in FIG. 7. As depicted in FIG. 7, the configuration file defines the threshold amount of time that the AUGIE computing entity 106 should spend processing during unit test code generation before skipping or rollback of the unit test code generation as 50 seconds, the type of behavior when threshold amount of time is passed as skipping of the unit test code generation, and the path of the rules file as /home/users/projects/WCGEngine/rules.

As further depicted in FIG. 4, the parsing engine 402 is configured to tokenize the target software unit and generate, for each class of the target software unit, a structured class-wise representation of the target software unit. The parsing engine 402 is further configured to provide the structured class-wise representation to an intermediate data model collection engine 403.

The structured class-wise representation may describe a set of class feature data objects that include a class feature data object for each class of a set of packages that are deemed to be associated with the target software unit. For example, if the target software unit is associated with one package, the structured class-wise representation may describe a key-value pair that describes the package using the key and an array of class feature data objects for each class in the package as the value. As another example, if the target software unit is associated with multiple packages, the structured class-wise representation may describe a set of key-value pairs, where each key-value pair corresponds to a package that is associated with the target software unit and describes the corresponding package using the key and an array of class feature data objects for each class in the corresponding package as the value. Thus, as described in the preceding two examples, the structured class-wise representation may describe one or more key-value pairs, where each key-value pair describes the class feature data objects for a set of classes in a package. For example, a key-value pair in a structured class-wise representation may describe, as the value of the key-value pair, a set of JavaScript Object Notation (JSON) objects, where JSON object corresponds to the class feature data object of a class in the package described by the key of the key-value pair.

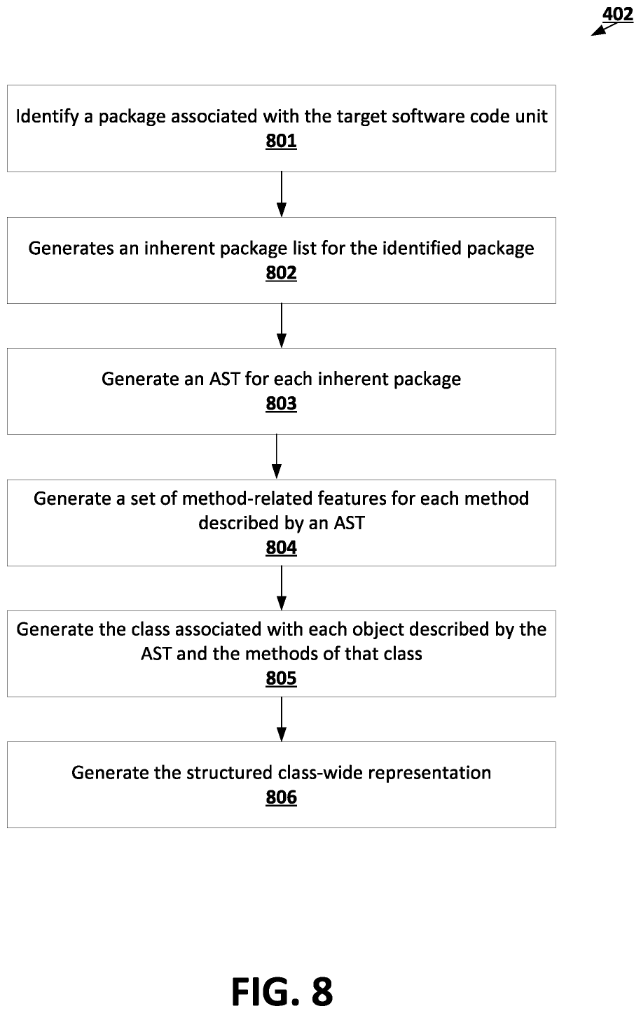

In some embodiments, the parsing engine 402 performs the steps/operations that are depicted in FIG. 8, which is a flowchart diagram of an example process for generating a structured class-wise representation of a target software code unit. While various embodiments of the present invention describe performing the process of FIG. 8 with respect to a target software code unit that includes a single package, a person of ordinary skill in the relevant technology will recognize that the noted process can be performed with respect to a multi-package target software code unit.

The process that is depicted in FIG. 8 begins at step/operation 801 when the parsing engine 402 identifies a package associated with the target software unit. For example, if the target software unit is a class, the parsing engine 402 adopts the package to which the class beings as the identified package associated with the target software unit.

At step/operation 802, the parsing engine 402 generates an inherent package list for the identified package. The inherent package list for an identified package may include, in addition to the identified package, any packages in a set of interdependent modules for a module that is associated with the identified package. In some embodiments, to generate the inherent package checklist for an identified package, the parsing engine 402: (i) identifies the target module associated with the package, (ii) identifies the project associated with the target module, (iii) identifies the Project Object Model (POM) file associated with the project, (iv) determines a set of interdependent module names for a set of interdependent modules for the target module based at least in part on the POM file, (v) scans the POM file based at least in part on the set of interdependent module names to determine the package list for each of the interdependent modules, and (vi) generates the inherent package list based at least in part on each package list for an interdependent module.

At step/operation 803, the parsing engine 402 generates an Abstract Syntax Tree (AST) for each inherent package in the inherent package list. The AST for a package may be generated using JavaParser. As depicted in the below Logical Diagram 1, an AST for a package may describe the package declaration for the package. As further depicted in the below Logical Diagram 1, the AST for a package may describe, for each class or interface in the package, a class or interface declaration for the class or interface, field declarations for any data fields defined by the class or interface, and the primitive type for each field declaration by the class or interface.

At step/operation 804, the parsing engine 402 generates, for each method described by an AST, a set of method-related features. This step/operation may include resolving method calls in the AST and may be performed to resolve method calls in a class that belong to objects external to the class. In some embodiments, resolving method calls in the generated ASTs may be performed using Java Symbol Solver.

In some embodiments, to resolve a method call, at least one of the following information are captured for each method call: whether the corresponding method is static, whether the corresponding method is abstract, whether the corresponding method has a void type, method return information for the corresponding method (e.g., whether the corresponding method returns anything, the data type returned by the corresponding method, and/or the like), method argument parameter information for any argument parameters of the corresponding method, method variable name information for any variables declared in the corresponding method, method variable data type information for any variables declared in the corresponding method, method object declaration information for any object declarations in the corresponding method, method loop information for any loops in the corresponding method, method conditional statement information for any conditional statements in the corresponding method, and/or the like.

At step/operation 805, the parsing engine 402 generates, for each object described by an AST, the class associated with the object and the methods of that class. In some embodiments, the parsing engine 402 resolves external object method dependencies for any detected objects. In some embodiments, the parsing engine 402 collects information about the class to which each object belongs and the methods of that class. In some embodiments, step/operation 805 is performed using the Reflections API.

At step/operation 806, the parsing engine 402 generates the structured class-wise representation. In some embodiments, the parsing engine 402 generates the structured class-wise representation based at least in part on each set of method-related features for a method described by an AST, each class for an object described by an AST, and each set of methods for a class of an object described by an AST.

As further depicted in FIG. 4, the intermediate data model collection engine 403 stores the structured class-wise representation as an off-heap data structure. In some embodiments, subsequent to storing structured class-wise representation as an off-heap data structure, the intermediate data model collection engine 403 provides the off-heap data structure to the dependency resolver 404.

In some embodiments, the intermediate data model collection engine 403 stores the structured class-wise representation as an off-heap data structure using ChronicleMap. In some embodiments, storing the structured class-wise representation as an off-heap data structure is important because, for the AUGIE computing entity 106 to generate unit test code, the AUGIE computing entity 106 may have to resolve dependencies involving external classes and methods, which in turn may require storing information related to all the classes in an easily accessible data structure and in an easily readable and serializable format, such as using off-heap data structure. In some embodiments, storing the structured class-wise representation as an off-heap data structure is important because off-heap data structures serialize objects on disks rather than by holding them in memory, which will avoid performance issues of on-head collections such as delays or program terminations due to insufficient memory resulted from having a large number of object creations. In some embodiments, storing the structured class-wise representation as an off-heap data structure is important because off-heap data structures avoid using excess heap space.

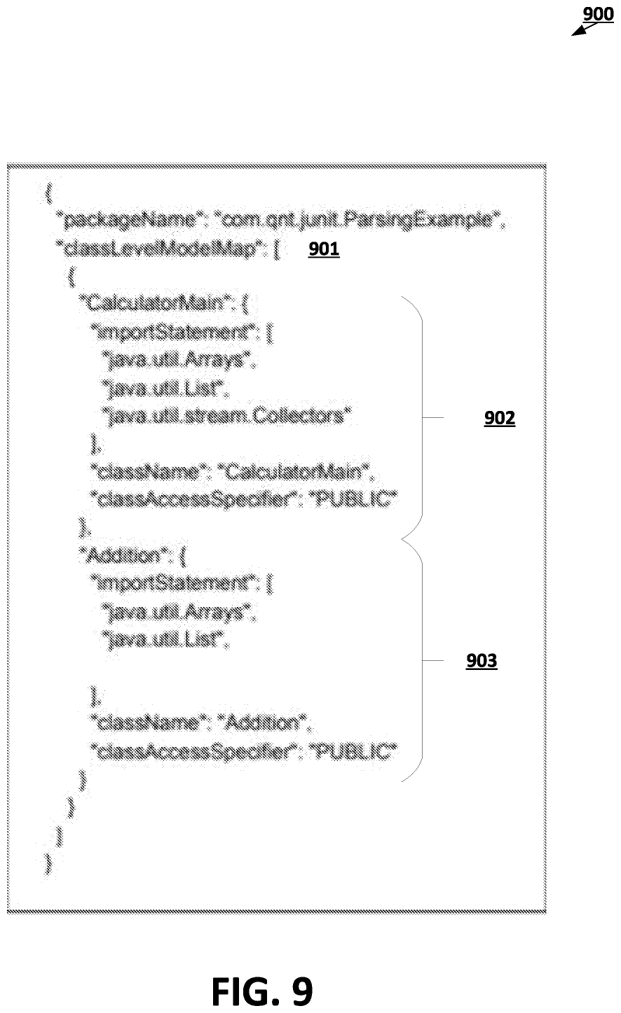

An operational example of the logical diagram of an off-heap data structure 900 storing the structured class-wise representation for a package is depicted in FIG. 9. As depicted in FIG. 9, the off-heap data structure 900 describes a package name 901 and two class feature data objects 902-903 for two classes, where each class feature data object describes packages imported by a corresponding class, a name of a corresponding class, and an access type of the corresponding class.

As further depicted in FIG. 4, the dependency resolver 404 augments the off-heap data structure by mapping each imported package for a class as described by the off-heap data structure to properties of any methods in the imported package that are used by the class, such as to at least one of method argument information for any methods in the imported package that are used by the class and method return type information for any methods in the imported package that are used by the class. In some embodiments, the dependency resolver 404 provides the augmented off-heap data structure to a sequence generator 405.

In some embodiments, the operations performed by the dependency resolver avoid having to perform multiple lookup operations by subsequent components present in the software architecture and the resulting runtime overhead of those lookup operations. In some embodiments, the dependency resolver 404 performs the operations of the Pseudocode Segment 1 for each imported package of a class as described by the off-head data structure.

Pseudocode Segment 1

ClassLevelDetail
map<packageName.CurrentclassName.externalClassName,
value>
where, value will be any of the following as per their usage -
1. Map<methodID.functionName,Model>
2. Map<staticBlock, Model>
Where Model is a class with the following attribute
1. method arguments
2. method return type

As further depicted in FIG. 4, the sequence generator 405 generates an executable sequence of methods as described by the augmented off-heap data structure, where the executable sequences are provided to the service bus 406. In some embodiments, the executable sequences are generated based at least in part on dependencies between methods. For example, if a function a( ) invokes a function b( ) where b( ) returns a result back to a( ) at the end of its operations, the executable sequence should be generated in a manner such that all of the statements of a( ) and b( ) appear in the order/sequence in which they are being executed and in a single test method. The sequence generator 405 provides the executable sequence of methods to the service bus 406, which in turn provides them to the method category identifier 407.

As further depicted in FIG. 4, the method category identifier 407 is configured to process methods in the executable sequence in the order defined by the executable sequence and, for each method, determine a method category. In some embodiments, the method category identifier 407 is further configured to provide each method category to the code generation engine 408.

In some embodiments, a method is associated with a set of method features. Examples of method features for a method include a method access modifier (e.g., a method access modifier describing whether the method is public, private, default, or protected), a method return type (e.g., a method return type describing whether the corresponding method has a primitive return type, a custom return type such as an object return type, a void return type, or a list return type), one or more method function call scope counts (e.g., one or more of the following: an internal method function call scope count describing a number of internal method invocations of the method within the class of the method and an external method function call scope count describing a number of external method invocations of the method outside of the class of the method), a number of conditional statements in the method, a number of input parameters of the method, a number of custom objects of the method, and an object of each conditional statement in the method (e.g., whether the conditional statement is based at least in part on primitive types such as for example by comparing two integers, custom types such as for example by determining if a custom object is an instance of another object, collections such as for example by determining if a conditional variable is in an array or list, or a method call such as for example by determining whether the Boolean output of a method call returns a true value).

Operational examples of method features are depicted in Table 1 that is provided below.

TABLE 1

| Features | Expected Values |
|---|---|
| Access Modifier | Public, private, default, protected |
| Return type | Primitive, custom, void, list |
| Function call | Internal, external |
| Conditional statements | Number of conditional statements |
| Input parameters | Number of input parameters |
| Custom objects | Number of custom objects in a function |
| Object of condition | Primitive, custom, collection, method call |

In some embodiments, the method category for a method describes the output of a method category determination machine learning model in relation to whether the method within the context of a target software code unit is deemed to be a functionally significant method in a manner that indicates a need for performing a unit testing operation with respect to the method. In some embodiments, the method category is generated by a method category determination machine learning model, such as a method category determination machine learning model that is trained using training data inferred based at least in part on existing unit tests for software programs.

In some embodiments, the method category determination machine learning model is configured to process a set of method features for a method to determine a method category for the method. Examples of method features for a method that may be used by a method category determination machine learning model include a method access modifier (e.g., a method access modifier describing whether the method is public, private, default, or protected), a method return type (e.g., a method return type describing whether the method has a primitive return type, a custom return type such as an object return type, a void return type, or a list return type), one or more method function call scope counts (e.g., one or more of the following: an internal method function call scope count describing a number of internal method invocations of the method within the class of the method and an external method function call scope count describing a number of external method invocations of the method outside of the class of the method), a number of conditional statements in the method, a number of input parameters of the method, a number of custom objects of the method, and an object of each conditional statement in the method (e.g., whether the conditional statement is based at least in part on primitive types such as for example by comparing two integers, custom types such as for example by determining if a custom object is an instance of another object, collections such as for example by determining if a conditional variable is in an array or list, or a method call such as for example by determining whether the Boolean output of a method call returns a true value).

In some embodiments, the method category determination machine learning model comprises an ensemble sub-model that is configured to combine the outputs of two or more prediction sub-models to generate the method category. For example, the method category determination machine learning model may comprise n prediction sub-models, where each prediction sub-model is associated with a trained, tuned, and/or preconfigured model weight and is configured to generate an output describing whether an inferred prediction about whether a method is deemed to be a functionally significant method in a manner that indicates a need for performing a unit testing operation with respect to the method. In the noted example, the ensemble sub-model may be configured to apply the model weight for each prediction sub-model to the per-model output of the prediction sub-model to generate a weighted per-model output for the prediction sub-model. Moreover, the ensemble sub-model may further be configured to combine each weighted per-model output for a prediction sub-model to generate the method category.

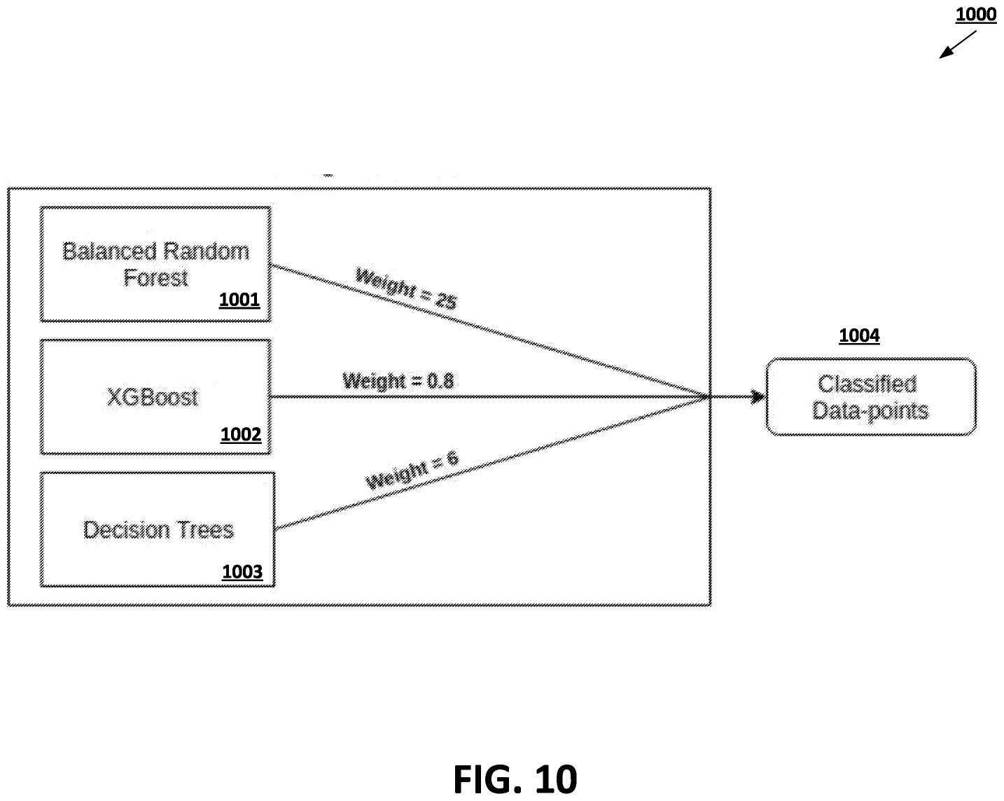

An operational example of a method category determination machine learning model 1000 is depicted in FIG. 10. As depicted in FIG. 10, the method category determination machine learning model 1000 comprises the following three prediction sub-models: the balanced random forest prediction sub-model 1001 that is associated with a tuned model weight of 25, the XGBoost prediction sub-model 1002 that is associated with a tuned model weight of 0.8, and the decision-tree-based prediction sub-model 1003 that is associated with a tuned model weight of 6. As further depicted in FIG. 10, the method category determination machine learning model 1000 further comprises the ensemble sub-model 1004 that is configured to combine the weighted per-model outputs of the three prediction sub-models in accordance with the depicted tuned model weights to generate a method category for a method.

In some embodiments, the input to the method category determination machine learning model include a vector or a matrix that describes a set of method features for an input method. In some embodiments, the output of the method category is a method category for the input method that may be an atomic value or a vector. In some embodiments, when the method category determination machine learning model comprises a set of prediction sub-models and an ensemble sub-model: (i) the input to each prediction sub-model may include a vector or a matrix that describes a set of method features for an input method, (ii) the output of each prediction sub-model may include a per-model output that may be an atomic value or a vector, (iii) the inputs to the ensemble sub-model may include an output vector that describes each per-model output of a prediction sub-model and a weight vector that describes each model weight for a prediction sub-model, and (iv) the output of the ensemble sub-model may be a method category for the input method that may be an atomic value or a vector.

In some embodiments, by using the method category identifier 407, various embodiments of the present invention address problems associated with scalability of unit testing solutions. Scalability refers herein to the ability of the proposed solutions to enable using more attributes for detecting functionally significant code segments. In this sense, various embodiments of the present invention enable scalable functionally significant code identification by training a retrainable method category determination machine learning model to generate machine-learning-based method categories for particular methods. Therefore, various embodiments of the present invention address technical issues associated with scalability of automated unit testing in a functionally targeted manner.

As further depicted in FIG. 4, the code generation engine 408 is configured to generate a unit testing code for each method that is deemed to be a functionally significant method based at least in part the method category. In some embodiments, the code generation engine 408 generates a unit testing code for a method if the method is deemed to be a functionally significant method by the method category determination machine learning model.

Subsequent to generating the unit testing codes, the code generation engine 408 executes the unit testing codes using a mocking framework 409 and based on simulation data provided by the simulation data generation engine 410 to generate a testing output 411. In some embodiments, the simulation data generation engine 410 includes an automatic test suite generation engine such as EvoSuite, a token model, and a mocking data generator such as JavaFaker.

By disclosing the above-noted techniques for functionally targeted unit testing, various embodiments of the present invention limit unit testing operations on critical code segments, rather than all code segments. Achieving this objective reduces the number of erroneous and/or excessive unit testing operations by automated software testing platforms. In some embodiments, reducing the number of erroneous and/or excessive unit testing operations improves the operational efficiency of test automation platforms by reducing the number of processing operations that need to be executed by the noted test automation platforms to enable software testing operations (e.g., automated software testing operations). By reducing the number of processing operations that need to be executed by the noted test automation platforms to enable software testing operations, various embodiments of the present invention make important technical contributions to the field of software application testing. Accordingly, by enhancing the accuracy and reliability of automated testing workflow data entities generated by software testing engineers, the user-friendly and intuitive unit testing techniques described herein improve the operational reliability of software application frameworks that are validated using the improved software testing operations described herein. By enhancing the operational reliability of software application frameworks that are validated using the improved software testing operations described herein, various embodiments of the present invention make important technical contributions to the field of software application framework.

Ina addition, various embodiments of the present invention address problems associated with scalability of unit testing solutions. Scalability refers herein to the ability of the proposed solutions to enable using more attributes for detecting functionally significant code segments. In this sense, various embodiments of the present invention enable scalable functionally significant code identification by training a retrainable method category determination machine learning model to generate machine-learning-based method categories for particular methods. Therefore, various embodiments of the present invention address technical issues associated with scalability of automated unit testing in a functionally targeted manner.

Moreover, various embodiments of the present invention improve the operational reliability and computational efficiency of software solutions which are generated using unit testing techniques described herein. As described in-depth throughout this disclosure, various embodiments of the present invention provide methods, apparatus, systems, computing devices, computing entities, and/or the like for performing functionally targeted unit testing by executing a set of functionally targeted testing operations with respect to a subset of one or more methods within the target software code unit that are associated with a functionally targeted method category, where the method category for a method is generated by utilizing a method category determination machine learning model and based at least in part on a set of method features for the method. The noted techniques enable improved unit testing solutions that lead to detecting operational errors in functionally significant portions of the code and fixing those operational errors. In this way, various embodiments of the present invention improve the operational reliability and computational efficiency of software solutions which are generated using unit testing techniques described herein.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for executing a set of functionally targeted unit testing operations with respect to a target software code unit, the computer-implemented method comprising:
identifying, using one or more processors, one or more methods within the target software code unit;
for each method, determining, using the one or more processors, by utilizing a method category determination machine learning model, and based at least in part on a set of method features for the method, a method category for the method; and
executing, using the one or more processors, the set of functionally targeted testing operations with respect to a subset of the one or more methods that are associated with a functionally targeted method category.

2. The computer-implemented method of claim 1, wherein the set of method features for a method comprises a method access modifier for the method, a method return type for the method, one or more method function call scope counts for the method, a count of conditional statements in the method, a count of created objects in the method, and a conditional statement object identifier for the method.

3. The computer-implemented method of claim 1, wherein the method category determination machine learning model comprises a plurality of prediction sub-models and an ensemble sub-model.

4. The computer-implemented method of claim 3, wherein the plurality of prediction sub-models comprises a balanced random forest prediction sub-model, a gradient-boosting-machine-based prediction sub-model, and a decision-tree-based prediction sub-model.

5. The computer-implemented method of claim 3, wherein each prediction sub-model is associated with a tuned model weight.

6. The computer-implemented method of claim 5, wherein the ensemble sub-model is configured to:
for each prediction sub-model, apply the tuned model weight for the prediction sub-model to the per-model output for the prediction sub-model to generate a weighted per-model output for the prediction sub-model, and
determine the method category based at least in part on each weighted per-model output.

7. The computer-implemented method of claim 1, wherein the one or more methods comprise:
one or more internal methods that are associated with one or more internal methods defined within a package of target software code unit, and
one or more external methods that are associated with one or more external methods defined outside the package of target software code unit.

8. An apparatus for executing a set of functionally targeted unit testing operations with respect to a target software code unit, the apparatus comprising at least one processor and at least one memory including program code, the at least one memory and the program code configured to, with the processor, cause the apparatus to at least:
identify one or more methods within the target software code unit;
for each method, determine, by utilizing a method category determination machine learning model and based at least in part on a set of method features for the method, a method category for the method; and
execute the set of functionally targeted testing operations with respect to a subset of the one or more methods that are associated with a functionally targeted method category.

9. The apparatus of claim 8, wherein the set of method features for a method comprises a method access modifier for the method, a method return type for the method, one or more method function call scope counts for the method, a count of conditional statements in the method, a count of created objects in the method, and a conditional statement object identifier for the method.

10. The apparatus of claim 8, wherein the method category determination machine learning model comprises a plurality of prediction sub-models and an ensemble sub-model.

11. The apparatus of claim 10, wherein the plurality of prediction sub-models comprise a balanced random forest prediction sub-model, a gradient-boosting-machine-based prediction sub-model, and a decision-tree-based prediction sub-model.

12. The apparatus of claim 10, wherein each prediction sub-model is associated with a tuned model weight.

13. The apparatus of claim 12, wherein the ensemble sub-model is configured to:
for each prediction sub-model, apply the tuned model weight for the prediction sub-model to the per-model output for the prediction sub-model to generate a weighted per-model output for the prediction sub-model, and
determine the method category based at least in part on each weighted per-model output.

14. The apparatus of claim 8, wherein the one or more methods comprise:
one or more internal methods that are associated with one or more internal methods defined within a package of target software code unit, and
one or more external methods that are associated with one or more external methods defined outside the package of target software code unit.

15. A computer program product for executing a set of functionally targeted unit testing operations with respect to a target software code unit, the computer program product comprising at least one non-transitory computer-readable storage medium having computer-readable program code portions stored therein, the computer-readable program code portions configured to:
identify one or more methods within the target software code unit;
for each method, determine, by utilizing a method category determination machine learning model and based at least in part on a set of method features for the method, a method category for the method; and
execute the set of functionally targeted testing operations with respect to a subset of the one or more methods that are associated with a functionally targeted method category.

16. The computer program product of claim 15, wherein the set of method features for a method comprises a method access modifier for the method, a method return type for the method, one or more method function call scope counts for the method, a count of conditional statements in the method, a count of created objects in the method, and a conditional statement object identifier for the method.

17. The computer program product of claim 15, wherein the method category determination machine learning model comprises a plurality of prediction sub-models and an ensemble sub-model.

18. The computer program product of claim 17, wherein the plurality of prediction sub-models comprises a balanced random forest prediction sub-model, a gradient-boosting-machine-based prediction sub-model, and a decision-tree-based prediction sub-model.

19. The computer program product of claim 17, wherein each prediction sub-model is associated with a tuned model weight.

20. The computer-implemented method of claim 19, wherein the ensemble sub-model is configured to:
for each prediction sub-model, apply the tuned model weight for the prediction sub-model to the per-model output for the prediction sub-model to generate a weighted per-model output for the prediction sub-model, and
determine the method category based at least in part on each weighted per-model output.
